(19) United States
(12) Patent Application Publication
(10) Pub. No.: US 2007/0102267 A1
(43) Pub. Date: May 10, 2007

(54) Keypad with audio components

(75) Inventors: Philip A. Schentrup, Hollywood, FL (US); James L. Tracy, Coral Springs, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/267,433

(22) Filed: Nov. 4, 2005

(51) Int. Cl. H01H 13/72

(52) U.S. Cl. 200/5 A

(57) ABSTRACT

A keypad assembly (10) with embedded audio components can include a keypad and an audio component (14) within at least one key (12) of the keypad. At least one key can include an audio port (13). The keypad assembly can further include an insulating layer (18) or flexible circuit (21) between the audio component and a printed circuit board (17) as well as a switch (15) or other switch activation means on the printed circuit board for activating a function when the at least one key is depressed. The audio component can be a microphone or a speaker or an ultrasonic transducer for example. The keypad assembly can include a plurality of keys where each key in the plurality can have a microphone or speaker to form a microphone array or speaker array respectively. For example, the audio generating component can be formed using micro-electro-mechanical systems (MEMS) technology.

### FIELD

This invention relates generally to keypads, and more particularly to keypads having audio components.

### BACKGROUND

Keypads and audio generating components such as speakers and microphones are common items found in cellular phones and other electronic devices. Since keypads and the keys therein are generally small and audio generating components or other audio components have not traditionally been within the size of such keys, embedding such components within keys has not been contemplated.

### SUMMARY

Embodiments in accordance with the present invention can provide a keypad or keys having integrated or embedded audio components therein.

In a first embodiment of the present invention, a keypad assembly with embedded audio components can include a keypad and an audio component within at least one key of the keypad. At least one key can include an audio port. The keypad assembly can further include an insulating layer or flexible circuit between the audio component and a printed circuit board as well as a switch such as a popple switch or other switch activation means on the printed circuit board for activating a function when the at least one key is depressed. The audio component can be a microphone or a speaker or an ultrasonic transducer for example. The keypad assembly can include a plurality of keys where each key in the plurality of keys can have a microphone or speaker therein and forming a microphone array or speaker array respectively. For example, the audio component can be formed using micro-electro-mechanical systems (MEMS) technology.

In a second embodiment of the present invention, an electronic product having a keypad assembly with embedded audio components can include a keypad, an audio component within at least one key of the keypad, and a processor coupled to the audio generating component. The at least one key can include an audio port. The keypad assembly can further include an insulating layer or flexible circuit (or flex circuit) between the audio component and a printed circuit board and a switch on the printed circuit board for activating a function when the at least one key is depressed. The audio component can be a microphone or a speaker or an ultrasonic transducer. The keypad assembly can include a plurality of keys where each key in the plurality of keys has a microphone therein and forms a microphone array. Likewise, the keypad assembly can include a plurality of keys where each key in the plurality of keys has a speaker therein and forms a speaker array. As noted above, the audio generating component can be formed using micro-electro-mechanical systems (MEMS) technology. The electronic product can be any number of products including, but not limited to a cellular phone, a smart phone, a messaging device, a laptop computer, a personal digital assistant, a dictation device, a remote control, or an MP3 player.

In a third embodiment of the present invention, a keypad assembly can include a keypad having a plurality of keys and an audio component embedded within at least one key among the plurality of keys of the keypad. The at least one key having the audio component embedded therein can further include an audio port. The audio generating component can be a microphone or a speaker and at least two keys among the plurality of keys can each having the microphone or the speaker therein to form either a microphone array or a speaker array respectively.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

### BRIEF DESCRIPTION OF THE DRAWINGS

FIG. 1 is a side view illustration of a keypad assembly having an embedded audio generating component in accordance with an embodiment of the present invention.

FIG. 2 is a side view illustration of a similar keypad assembly to the keypad assembly of FIG. 1 using a flexible circuit instead of an insulating layer and wires in accordance with an embodiment of the present invention.

FIG. 3 is an illustration of an electronic device having a keypad assembly having an embedded audio generating component in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

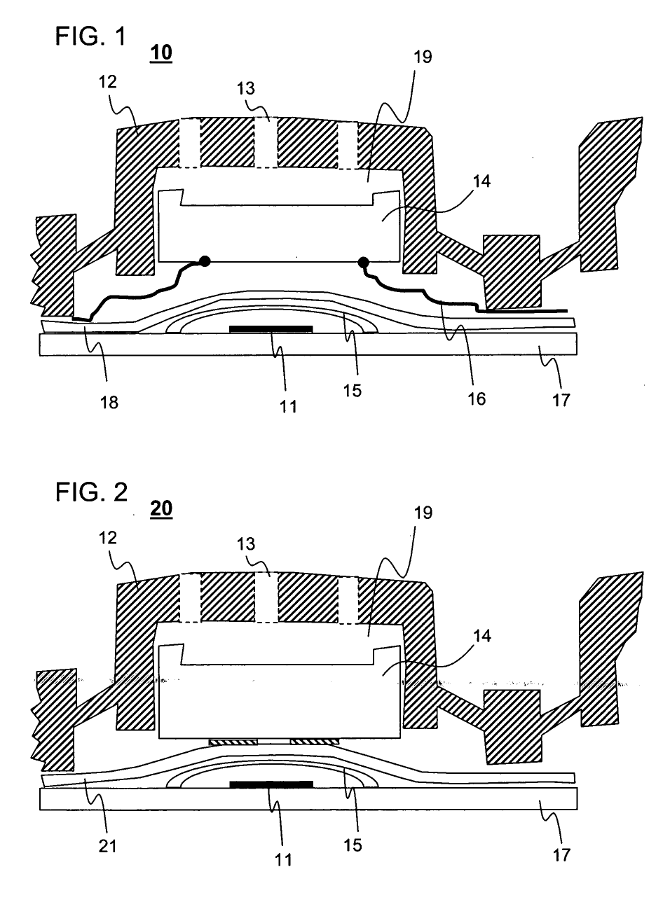

Referring to FIG. 1, a keypad assembly 10 in accordance with an embodiment of the present invention can include at least one key 12 having an audio component 14 embedded within the keypad assembly 10 and more specifically within the at least one key 12. The audio component 14 can be a speaker or a microphone for example. The key 12 can include one or more audio ports 13 to enable sound to travel out from the cavity 19 of the key or into the cavity 19. The keypad assembly 10 can further include wiring 16 to and from the audio component 14. The keypad assembly 10 can also include a printed circuit board (PCB) 17 having a switch 11 that is activated when the key 12 and a corresponding optional popple 15 is depressed. An insulative layer 18 can be used to insulate the wiring 16 from the switch 11, popple 15 or other circuitry that may be on the PCB 17. Referring to FIG. 2, a similar keypad assembly 20 to the keypad assembly 10 of FIG. 1 is shown. The keypad assembly 20 includes all the elements found in keypad 10, but substitutes a flexible circuit 21 for the insulating layer 18 and the wiring 16 to provide a more robust embodiment that avoids the use of wires. Note, the insulating layer or flexible circuits are optional and embodiments are contemplated herein that can be implemented without such elements. For example, connections can be made from the audio component 14 through the key 12 or keypad assembly 10 or 20 to the printed circuit board 17 (not shown).

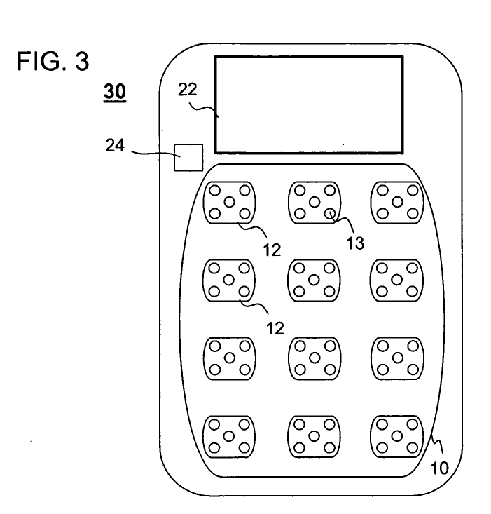

Referring to FIG. 3, an electronic product 30 such as a cellular phone, a smart phone, a messaging device, a laptop computer, a personal digital assistant, a dictation device, a remote control, or an MP3 player (or any number of other electronic devices) is illustrated. The electronic product 30 can include the keypad assembly 10 (or 20) as described above including one or more keys 12 having an integrated or embedded audio component and at least one audio port 13 in the key or keys. The electronic product 30 can further include other components such as a processor 24 or a display 22 as is found in many electronic products.

Currently, there are multiple vendors that are capable of providing miniature microphones small enough to use for the keypad assembly 10. Such microphones are available in both traditional and MEMS construction. For instance, a MEMS based microphone can be made in a square chip form factor that is sufficiently small enough to fit within a key or keypad. A company named Sonion recently announced the launch of their DigiSiMic™ microphone having a footprint of only 2.6×1.6 mm².

Speakers are currently not as small as microphones, but there are speakers the size of navigation keys. For instance, Sonion makes speakers 10×15 mm or 16 mm in diameter. Akustica on the other hand, is working on research to bring MEMS based technology to speakers that should dramatically shrink the size of speakers in the future. In addition to traditional speakers, embodiments herein can use ultrasonic transducers in order to generate audio similar to the ultrasonic transducer developed by Dr. Joseph Pompei from the Massachusetts Institute of Technology. Given the short wavelengths ultrasonic transducers produce, it should be possible to make these devices even smaller than traditional speakers.

In one implementation, the keypad assembly 10 can involve creating the key 12 with a hollow cavity 19 in the center of the key. An audio device 14 such as a microphone, speaker, or transducer can be inserted into the cavity 19 with wires 16 attaching to the bottom of the audio device 14 as illustrated in FIG. 1. The wires 16 can be replaced or be part of a flex circuit 21 as illustrated in FIG. 2 that can provide connections for one or more microphones. In between the audio component 14 and a standard keypad popple 15 can be the insulating layer 18 to ensure the popple and wiring remained electrically isolated. The key pad popple 15 can be the same or similar to key pad poppies currently used. Key presses can be detected by the user pressing a key, which causes the audio component 14 to press down on the popple 15 and the popple 15 would short a row/column signal or switch 11 that can be used by the processor 24 (in FIG. 3).

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

In light of the foregoing description, it should also be recognized that embodiments in accordance with the present invention can be realized in numerous configurations contemplated to be within the scope of the claims. Additionally, the description above is intended by way of example only and is not intended to limit the present invention in any way, except as set forth in the following claims.

1. A keypad assembly with embedded audio generating components, comprising:
a keypad having at least one key;
at least a microphone contained within the at least one key of the keypad, wherein the microphone captures acoustic waves external to the at least one key;
a flexible circuit connected to an underside of the at least one microphone; and
a popple switch that rests under the flexible circuit and has a top diaphragm portion and a flat bottom portion that is connected to a circuit board, wherein the popple switch is centered under the at least one microphone between the circuit board and the flexible circuit;
wherein the popple switch is open in a default configuration, and closed in response to a depressing action of the at least one key, wherein the depressing action causes the at least one microphone to exert a force on the flexible circuit which flexes to cause the top diaphragm portion to temporarily collapse and make contact with the flat bottom portion and close the popple switch, and the popple switch returns to the default configuration when the pressing action is released.

2. The keypad assembly of claim 1, wherein the at least one key further comprises an audio port that receives the acoustic waves external to the at least one key.

3. The keypad assembly of claim 1, wherein the keypad assembly further comprises an flexible circuit between the audio component and a printed circuit board.

4. The keypad assembly of claim 3, wherein the keypad assembly further comprises a switch on the printed circuit board for activating a function when the at least one key is depressed.

5. The keypad assembly of claim 1, wherein the microphone rests on top of the flex circuit forming a portion of the keypad assembly.

6. The keypad assembly of claim 1, wherein the audio component is a speaker or an ultrasonic transducer within at least another key of the keypad.

7. The keypad assembly of claim 1, wherein the keypad assembly comprises a plurality of keys, each key in the plurality of keys having a microphone therein and forming a microphone array.

8. The keypad assembly of claim 1, wherein the keypad assembly comprises a plurality of keys, each key in the plurality of keys other than the at least one key having the microphone having a speaker therein and forming a speaker array.

9. The keypad assembly of claim 1, wherein the audio generating component is formed using micro-electro-mechanical systems (MEMS) technology.

10. An electronic product having a keypad assembly with embedded audio generating components, comprising:
a keypad;
an audio component contained within at least one key of the keypad, wherein the audio component captures or transmits acoustic waves through at least one audio port of the at least one key;
a flexible circuit connected to an underside of the audio component between the audio component and a printed circuit board;
a processor coupled to the audio component and
a popple switch that rests under the flexible circuit and has a top diaphragm portion and a flat bottom portion that is connected to a circuit board, wherein the popple switch is centered under the audio component between the circuit board and the flexible circuit and operatively coupled to the processor;
wherein the popple switch is open in a default configuration, and closed in response to a depressing action of the at least one key, wherein the depressing action causes the audio component to exert a force on the flexible circuit which flexes to causes the top diaphragm portion to temporarily collapse and make contact with the flat bottom portion and close the popple switch, and the popple switch returns to the default configuration when the pressing action is released.

11. (canceled)

12. The electronic product of claim 10, wherein the keypad assembly further comprises an insulating layer between the audio component and a printed circuit board and a switch on the printed circuit board for activating a function when the at least one key is depressed.

13. The electronic product of claim 10, wherein the audio component is a microphone or a speaker or an ultrasonic transducer.

14. The electronic product of claim 10, wherein the keypad assembly comprises a plurality of keys, each key in the plurality of keys having a microphone therein and forming a microphone array.

15. The electronic product of claim 10, wherein the keypad assembly comprises a plurality of keys, each key in the plurality of keys having a speaker therein and forming a speaker array.

16. The electronic product of claim 1, wherein the audio component is formed using micro-electro-mechanical systems (MEMS) technology.

17. The electronic product of claim 1, wherein the electronic product further comprises a cellular phone, a smart phone, a messaging device, a laptop computer, a personal digital assistant, a dictation device, or an MP3 player.

18. A keypad assembly, comprising:
a keypad having a plurality of keys; and
at least two keys among the plurality of keys each having an audio component embedded within the at least two keys of the keypad to form an audio component array wherein
an audio component is contained within at least one key of the keypad, wherein the audio component captures or transmits acoustic waves through at least one audio port of the at least one key;
a flexible circuit is connected to an underside of the audio component between the audio component and a printed circuit board; and
a popple switch rests under the flexible circuit and has a top diaphragm portion and a flat bottom portion that is connected to a circuit board, wherein the popple switch is centered under the audio component between the circuit board and the flexible circuit and operatively coupled to the processor;
wherein the popple switch is open in a default configuration, and closed in response to a depressing action of the at least one key, wherein the depressing action causes the audio component to exert a force on the flexible circuit which flexes to causes the top diaphragm portion to temporarily collapse and make contact with the flat bottom portion and close the popple switch, and the popple switch returns to the default configuration when the pressing action is released.

19. The keypad assembly of claim 18, wherein the at least two keys having the audio component embedded further comprise an audio port.

20. The keypad assembly of claim 18, wherein the audio component is a microphone or a speaker and the at least two keys among the plurality of keys each having the microphone or the speaker therein form either a microphone array or a speaker array.
